(19) United States
(12) Patent Application Publication
(10) Pub. No.: US 2011/0012541 A1
(43) Pub. Date: Jan. 20, 2011

(54) WIRELESS SWITCHING APPLICATIONS

(76) Inventor: John Gerard Finch, Livonia, MI (US)

Correspondence Address: Carlson, Gaskey & Olds/Masco Corporation, 400 West Maple Road, Suite 350, Birmingham, MI, 48009, US

(21) Appl. No.: 12/667,909

(22) PCT Filed: Jul. 22, 2008
(86) PCT No.: PCT/US08/70699

§ 371 Date: Jan. 6, 2010

Related U.S. Application Data
(60) Provisional application No. 60/954,007, filed on Aug. 5, 2007.

(51) Int. Cl. H05B 37/02

(52) U.S. Cl. 315/362

(57) ABSTRACT

A wireless lighting system includes an enclosure containing a lighting load. The enclosure has a panel that is movable to access an inside of the enclosure, and the panel has a closed position and at least one open position. The system also includes a self-energizing switch that is actuated to transmit a wireless signal by a movement of the panel to or from the closed position. A receiver is operable to selectively couple the lighting load to a power supply in response to the signal from the self-energizing switch.

The application claims priority to U.S. Provisional Application No. 60/954,007 which was filed on Aug. 5, 2007.

### BACKGROUND OF THE INVENTION

This application relates to wireless switching concepts, and more specifically to applications for wireless switches that are also self-energizing.

Rooms such as kitchens often contain many enclosures such as cabinets, drawers, and pantries that are used to store a variety of items. Some of these enclosures utilize lighting, but turning such lighting ON and OFF can require manually actuating a switch in addition to accessing the enclosure.

### SUMMARY OF THE INVENTION

A wireless lighting system includes an enclosure containing a lighting load. The enclosure has a panel that is movable to access an inside of the enclosure, and the panel has a closed position and at least one open position. The system also includes a self-energizing switch that is actuated to transmit a wireless signal by a movement of the panel to or from the closed position. A receiver is operable to selectively couple the lighting load to a power supply in response to the signal from the self-energizing switch.

These and other features of the present invention can be best understood from the following specification and drawings, the following of which is a brief description.

### BRIEF DESCRIPTION OF THE DRAWINGS

FIG. 1 schematically illustrates an example wireless switching application.

FIG. 1a schematically illustrates an exploded drawing of a self-energizing switch of FIG. 1.

FIG. 2 schematically illustrates a plurality of wireless switching applications in a kitchen.

FIG. 3a schematically illustrates a first view of a first self-energizing hinge switch.

FIG. 3b schematically illustrates a second view of the self-energizing hinge switch of FIG. 3a.

FIG. 4a schematically illustrates a first view of a second self-energizing hinge switch.

FIG. 4b schematically illustrates a second view of the self-energizing hinge switch of FIG. 4a.

FIG. 5a schematically illustrates a drawer switch of FIG. 2 in a closed position.

FIG. 5b schematically illustrates the drawer switch of FIG. 2 in an open position.

### DETAILED DESCRIPTION OF THE PREFERRED EMBODIMENT

FIG. 1 schematically illustrates an example wireless switching application 10. A self-energizing switch 12 is operable to communicate wirelessly with a programmable receiver 14. In one example the wireless communication occurs through radio frequency (“RF”) signals. As shown in the exploded schematic drawing of FIG. 1a, the switch 12 includes an energy harvester 13 and a transmitter 15 operable to transmit a wireless signal. The energy harvester 13 is operable to harvest energy from an external source, such as a person actuating the switch, or a photovoltaic cell. Throughout this application the term “self-energizing switch” refers to a switch that is operable to harvest energy from an external source, and that is operable to transmit a wireless signal to the receiver 14. In one example, the self-energizing switch is batteryless. In one example, the switch 12 has an upper portion 12a and a lower portion 12b, and when the upper portion 12a is pressed the switch sends an ON signal, and when the lower portion 12b is pressed the switch sends an OFF signal. The receiver 14 is operable to selectively couple a lighting load 16a, 16b to a power supply 20 in response to a signal from the switch 12. For example, the receiver 14 could be programmed to turn ON or OFF load 16a and load 16b individually, or together in response to a signal from the switch 12.

One example self-energizing switch is available from EnOcean under Product No. PTM 250 and one example receiver is available from EnOcean under Product No. RCM130C. Although the receiver 14 as shown in FIG. 1 is a multi-channel receiver, it is understood that the receiver 14 could be a single channel receiver and could be coupled to more or less than two items. Also, it is understood that multiple receivers could be used in the switching application 10.

FIG. 2 schematically illustrates a plurality wireless switching applications in a kitchen 20. The kitchen 20 includes a plurality of cabinets 22a, 22b, 22c, and each cabinet has an associated panel 23a, 23b, 23c that is movable to access the contents of its associated cabinet. Each cabinet also includes at least one self-energizing hinge switch 24a, 24b, 24c. A refrigerator door 26 for a refrigerator 25 also includes a self-energizing hinge switch 24d, and a door 28 for a pantry 27 includes a self-energizing hinge switch 24e. The kitchen also includes a drawer enclosure 30 and a drawer 32 that is movable into the drawer enclosure 30. The drawer 30 includes a self-energizing drawer switch 34. The switches 24a-e and 34 are all operable to transmit wireless signals to the receiver 36.

The receiver 36 is electrically coupled to a cabinet light 39, a drawer light 40, a ceiling light 42, and a pantry light 46, and is operable to selectively couple the lights 38, 40, 42, and 46 to a power source 44 in response to a signal from the switches 24a-e, 34. Each of the cabinets 22a, 22b, 22c, doors 26, 28, and drawer 32 have an open and a closed position. Using the cabinet 22a as an example, opening the panel 23a from the closed position actuates the hinge switch 24a to transmit a wireless signal to the receiver 36. The receiver 36 uses software to process the signal and selectively turns the cabinet light 39 ON in response to the signal. When the panel 23a is closed, the hinge switch 24a is activated and a signal is transmitted to the receiver 36, which then turns OFF the cabinet light 39. Of course, the receiver 36 could be programmed to perform other actions in response to the signals. The cabinets 22b and 22c operate in a similar fashion so that the receiver turns ON a light in response to an open position and turns OFF the light in response to a closed position.

When the pantry door 28 opens, the switch 24e transmits a signal to receiver 36 and the receiver 36 turns ON the pantry light 46. When the pantry door 28 closes, the switch 24e transmits a signal to receiver 36 and the receiver 36 turns OFF the pantry light 46. Also, when the drawer 32 opens, the switch 34 transmits a signal to receiver 36 and the receiver 36 turns the drawer light 40 ON. When the drawer 32 closes, the switch 34 transmits a signal to the receiver 36 and the receiver 36 turns the drawer light 40 OFF. The example of FIG. 2 could also be modified so that the pantry light 46 is a light in an attic, a crawlspace, or another region in a house. Similarly, opening the refrigerator door 26 activates the hinge switch 24d to send a signal to the receiver 36. The receiver 36 could then use software to process the signal and issue a notification, such as turning on the ceiling light 42.

In another example, if a hinged door, such as the cabinet door 23a, is only partially closed, then the receiver 36 issues a notification, such as a sound, light flash, light turn ON, or light turn OFF, in response to a signal from a hinge switch, such as the hinge switch 24a.

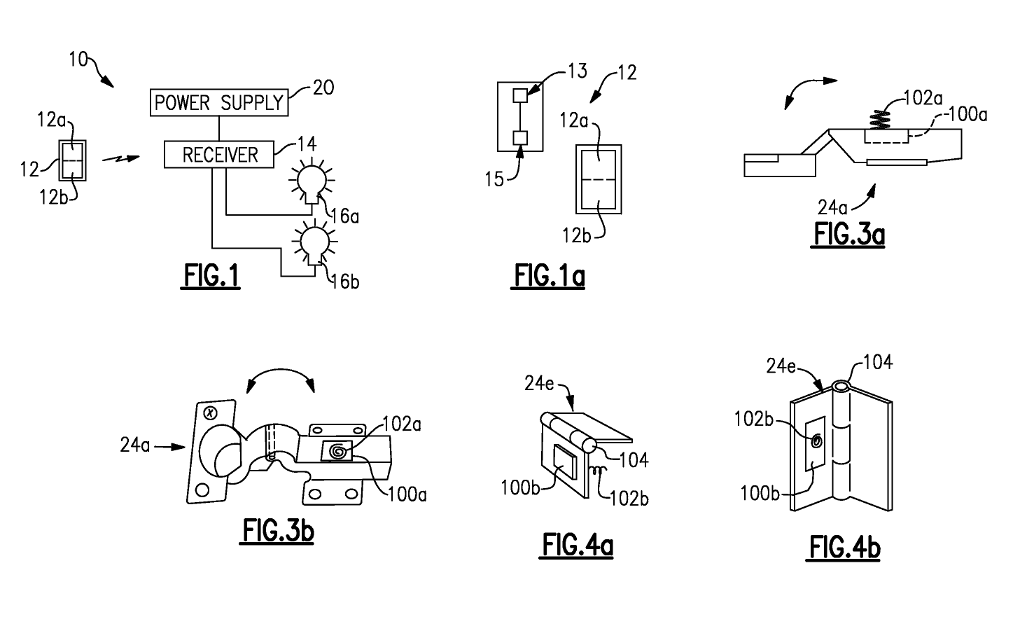

A self-energizing switch may be built into a hinge to form a hinge switch so that a motion of the hinge is used to harvest energy to enable the hinge switch to transmit a wireless signal to a receiver, such as the receiver 36. FIG. 3a schematically illustrates a first view an example self-energizing switch 24a for a cabinet. The switch 24a includes an energy harvester 100a and a spring 102a coupled to the energy harvester 100a. When the hinge switch 24a is opened, the spring 102a is released, activating the energy harvester 100a to generate an electric current which the hinge switch 24a uses to transmit a signal to a receiver, such as the receiver 36 of FIG. 2. When the hinge switch 24a is closed the spring 102a is compressed, activating the energy harvester 100a to provide power to the hinge switch 24a, which could then optionally transmit a signal to the receiver 36. FIG. 3b schematically illustrates a second view of the example hinge switch 24a.

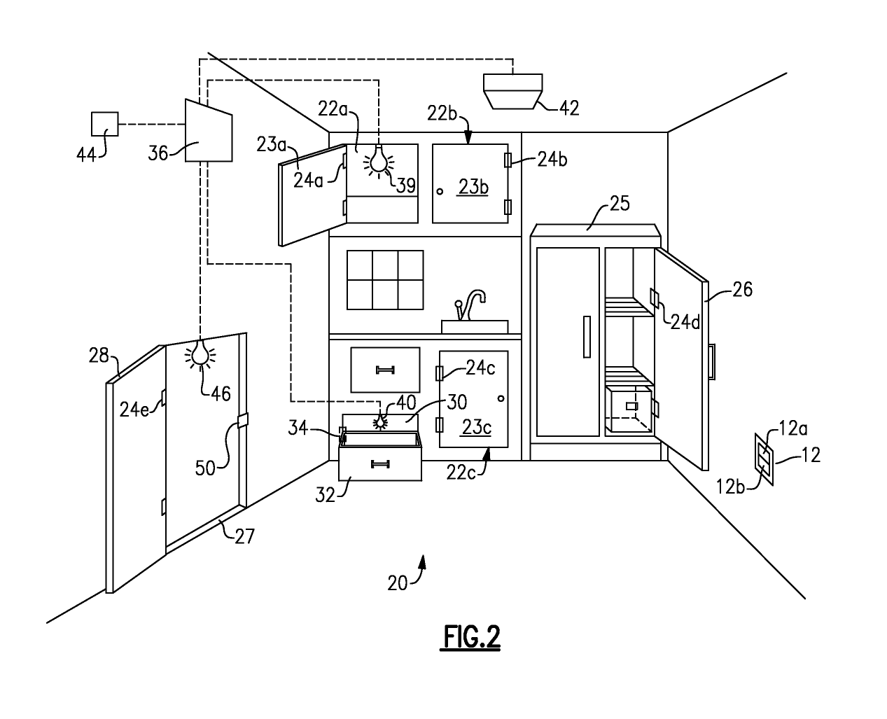

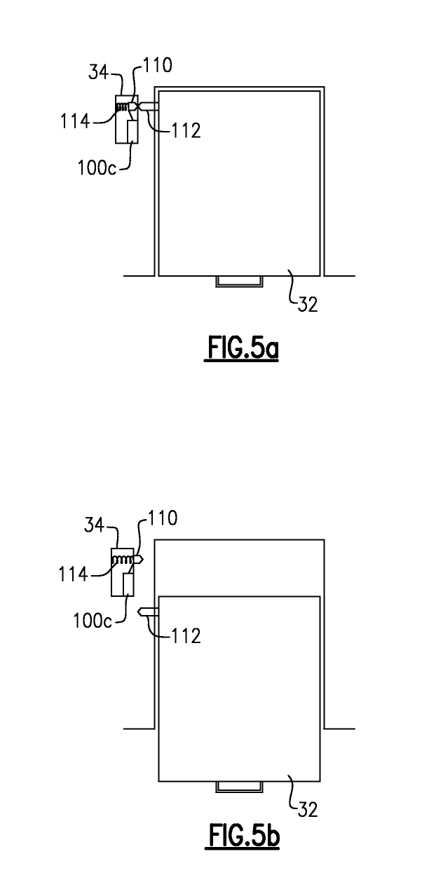

FIG. 4a schematically illustrates a first view of the self-energizing hinge switch 24e for a door. The hinge switch 24e includes an energy harvester 100b and a 102b coupled to the energy harvester 100b. The hinge switch 24e rotates about a pin 104. When the hinge switch 24e is opened, the spring 102b is released, activating the energy harvester 100b to generate an electric current which the hinge switch 24e may use to transmit a signal to a receiver, such as the receiver 36 of FIG. 2. When the hinge switch 24e is closed, the spring 102b is compressed, activating the energy harvester 100 to transmit another signal to the receiver 36. FIG. 4b schematically illustrates a second view of the example hinge switch 24e. In another example, the energy harvester 100b could be built into the pin 104. In such an example, an existing hinge could be converted into a hinge switch by simply replacing a pin in the hinge. It is understood that the schematic illustrations of FIGS. 3a, 3b, 4a and 4b are only exemplary, and that other hinge switches could be used.

FIG. 5a schematically illustrates the drawer switch 34 of FIG. 2 in a closed position. The drawer switch 240 includes an energy harvester 100c, a movable arm 110, and a spring 114. The drawer 32 includes an extension 112. When the drawer 32 is in a closed position, the extension 112 keeps the movable arm 110 in a recessed position. FIG. 5b schematically illustrates the drawer switch 34 in an open position. When the drawer 32 opens, the spring 114 is released, which activates the energy harvester 100c. Similarly, when the drawer 32 closes, the extension 110 compresses the spring 114 which activates the energy harvester 100c. When the energy harvester 100c is activated, it harvests energy that the drawer switch 34 may use to transmit a signal to a receiver, such as the receiver 36 of FIG. 2. As discussed above, the receiver 36 could be programmed to turn ON the light 40 when the drawer 32 is opened, and to turn OFF the light 40 when the drawer 32 is closed.

Although a preferred embodiment of this invention has been disclosed, a worker of ordinary skill in this art would recognize that certain modifications would come within the scope of this invention. For that reason, the following claims should be studied to determine the true scope and content of this invention.

What is claimed is:

1. A wireless lighting system comprising:
an enclosure surrounding a lighting load, the enclosure having a panel movable to access an inside of the enclosure, the panel having a closed position and at least one open position;
a self-energizing switch that is actuated to transmit a wireless signal by a movement of the panel to or from the closed position; and
a receiver operable to selectively couple the lighting load to a power supply in response to the signal from the self-energizing switch.

2. The system of claim 1, wherein the enclosure is a cabinet, the panel is a cabinet door, and the self-energizing switch is coupled to a hinge of the cabinet door and is actuated by opening or closing the cabinet door.

3. The system of claim 1, wherein the enclosure is a refrigerator, the panel is a refrigerator door, and the self-energizing switch is coupled to a hinge of the refrigerator door and is actuated by opening or closing the refrigerator door.

4. The system of claim 1, wherein the enclosure corresponds to a pantry, the panel corresponds to a pantry door, and the self-energizing switch corresponds to a hinge of the pantry door and is actuated by opening or closing the pantry door.

5. The system of claim 1, wherein the enclosure is a closet, the panel is a closet door, and the self-energizing switch is coupled to a hinge of the closet door and is actuated by opening or closing the closet door.

6. The system of claim 1, wherein the enclosure is a drawer enclosure, the panel is drawer that is movable within the drawer enclosure, and the self-energizing switch is located within the drawer enclosure and is actuated by opening or closing the drawer.

7. The system of claim 1, wherein the enclosure is a crawlspace, the panel is a crawlspace door, and the self-energizing switch is coupled to a hinge of the crawlspace door and is actuated by opening or closing the crawlspace door.

8. The system of claim 1, wherein the enclosure is an attic, the panel is an attic access panel, and the self-energizing switch is coupled to a hinge of the attic access panel and is actuated by opening or closing the attic access panel.
